(19) United States
(12) Patent Application Publication
(10) Pub. No.: US 2005/0241347 A1
(43) Pub. Date: Nov. 3, 2005

(54) Detergent supply apparatus of washing machine

(75) Inventors: Han Ki Cho, Changwon-si (KR); Yang Hwan No, Changwon-si (KR); Jung Hoon Kang, Changwon-si (KR); Jong Min Kim, Changwon-si (KR); Ho Sung Jang, Hadong-kun (KR); Dong Hoon Kang, Pusanjin-ku (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/104,639

(22) Filed: Apr. 13, 2005

(30) Foreign Application Priority Data
Apr. 14, 2004 (KR) 2004-25965

(51) Int. Cl. C11D 1/00; D06F 51/02

(52) U.S. Cl. 68/243; 510/225

(57) ABSTRACT

Disclosed herein is a detergent supply apparatus of a washing machine, which installs a liquid detergent container in a powdered detergent chamber of a detergent container. The liquid detergent container makes it possible to mix and supply liquid detergent and water, which allows liquid detergent to be conveniently placed in, moreover, decoloration and discoloration of laundry to be prevented.

### BACKGROUND OF THE INVENTION

1. Field of the Invention

The present invention relates to a detergent supply apparatus of a washing machine, more particularly, which is capable of supplying liquid detergent and water to a tub of the washing machine.

2. Description of the Related Art

A washing machine is to decontaminate dirt on clothes or bedding (hereinafter referred as “laundry”) contained in a drum. It cleans laundry through washing, rinsing, dehydrating and drying.

The washing machine has a detergent supply apparatus to supply powdered detergent or fabric softner mixed with water supplied.

The use of liquid detergent is increasingly so popular that it prevents a water supply passage of a detergent container from clogging due to powered detergent, besides, it brings more powerful washing effect.

However, the conventional detergent supply apparatus of the washing machine has no additional detergent chamber for liquid detergent but a powdered detergent chamber. Inevitably, liquid detergent is directly poured in and touched with laundry, which causes decoloration and discoloration of laundry.

### SUMMARY OF THE INVENTION

Accordingly, it is an object of the present invention to provide a detergent supply apparatus of a washing machine, which supplies liquid detergent together with water and protects against decoloration and discoloration of laundry.

Another object of the present invention is to provide the detergent supply apparatus of the washing machine, which makes it possible to easily place powdered detergent or liquid detergent according to circumstances.

To achieve the above and other objects of the present invention, a detergent supply apparatus of a washing machine according to the present invention comprises a detergent container having a powdered detergent chamber which stores powdered detergent, and a liquid detergent container detachably set in the powdered detergent chamber, which stores liquid detergent.

The detergent container has a plurality of powdered detergent chambers, and the liquid detergent container is detachably set in each of the powdered detergent chambers.

The powdered detergent chamber is partitioned into a main detergent storing section for main washing and a preliminary detergent storing section for preliminary washing.

The liquid detergent container is furnished with a main liquid detergent container detachably set in the main detergent storing section and a subsidiary liquid detergent container detachably set in the preliminary detergent storing section.

The detergent container has a fabric softner storing section where fabric softner is accommodated and a siphon is protruded. A fabric softner cover covers the fabric softner storing section and provides a water drain passage with the siphon.

The detergent container has a bleach storing section where bleach is accommodated and a siphon is protruded. A bleach cover covers the bleach storing section and provides the water drain passage with the siphon.

A plurality of protrusions is existed in a bottom of the liquid detergent container, which makes apart its bottom from the corresponding area of the powdered detergent chamber by predetermined distance.

A plurality of protrusions is existed in a side of the liquid detergent container, which makes apart its side from the corresponding area of the powdered detergent chamber by predetermined distance.

Height of the liquid detergent container is lower than that of the powdered detergent chamber.

The liquid detergent container has a protruded siphon and a liquid detergent siphon cover which covers the siphon and provides the water drain passage together with the siphon.

The liquid detergent container has a downward sloping surface toward the siphon in a lower part.

The liquid detergent siphon cover has a straight portion which is suspended on a wall of the liquid detergent container so as to restrict its rotation.

The liquid detergent siphon cover has an indication portion in a stepwise manner, which shows the maximum quantity of liquid detergent.

The detergent supply apparatus of the washing machine according to the present invention comprises the detergent container having the powdered detergent chamber, and the liquid detergent container detachably set in the powdered detergent chamber.

The detergent supply apparatus of the washing machine according to the present invention comprises a housing installed in the washing machine, which is open at its front and top, the detergent container having the detergent chambers, which is inserted in the housing through a front of the housing, a dispenser having a plurality of water supply passages to inject water into the detergent chamber, which covers a top surface of the housing, and the liquid detergent container detachably set in the detergent chamber so as to mix and supply liquid detergent and water together.

The detergent container is partitioned into the detergent sections.

The detergent chambers include the main detergent storing section, the preliminary detergent storing section, the bleach storing section, and the fabric softner storing section.

The liquid detergent container has the protruded siphon and the liquid detergent siphon cover which covers the siphon and provides the water drain passage together with the siphon.

The washing machine according to the present invention comprises a cabinet, a tub mounted in the cabinet, a drum rotatably set in the tub, the housing installed in the cabinet, the detergent container having the powdered detergent chamber so as to mix and supply powdered detergent and water together, which is inserted into the housing, the dispenser having the water supply passage to inject water into the powdered detergent chamber, which covers the top surface of the housing, and the liquid detergent container detachably set in the powdered detergent chamber so as to mix and supply liquid detergent and water together.

According to the present invention, the liquid detergent container is installed in the powdered detergent chamber of the detergent container, which mixes and supplies liquid detergent and water together. Liquid detergent can be simply supplied. As liquid detergent diluted with water soaks laundry, decoloration and discoloration of laundry can be protected.

The liquid detergent container is detachably set in the powdered detergent chamber of the detergent container, on that account, liquid detergent or powdered detergent can be easily placed in depending on a user's intention

The detergent container has the powdered chambers and the liquid detergent container is detachably set in each of the powdered detergent chambers, on that account, liquid detergent and powdered detergent can be used together.

The powdered detergent chamber is partitioned into the main detergent storing section and the preliminary detergent storing section. The liquid detergent container is replenished with the main liquid detergent container detachably set in the main detergent storing section and the subsidiary liquid detergent container detachably set in the preliminary detergent storing section. If either the main liquid detergent container or the subsidiary liquid detergent container is installed in the detergent container, a different type of detergent can be used in a main and preliminary washing process. The washing power can be much more improved.

The bottom of the liquid detergent container is parted from that of the powdered detergent storing section by predetermined distance, on that account, liquid detergent and water can easily flow without stagnating.

The side of the liquid detergent container is parted from that of the powdered detergent chamber by predetermined distance and a top of the liquid detergent container is lower than that of the powdered detergent chamber, on that account, liquid detergent and water does not overflow into another place. It can prevent the unnecessary use of detergent.

The liquid detergent container has the protruded siphon and the liquid detergent siphon cover which covers the siphon and provides the water drain passage together with the siphon, on that account, mixing and supplying liquid detergent and water is simply possible.

The lower part of the liquid detergent container has the downward sloping surface toward the siphon, on that account, remaining liquid detergent can be minimized.

The liquid detergent siphon cover has the straight portion which is suspended on the wall of the liquid detergent container in order to restrict its rotation, on that account, an additional structure, i.e. a hook, fixing the liquid detergent siphon cover is not required and noise from the vibration of the washing machine can be minimized.

The liquid detergent siphon cover has the indication portion in a stepwise manner, which shows the maximum quantity of liquid detergent, on that account, the user can easily notice the maximum quantity of liquid detergent. It can prevent the excessive use of liquid detergent and even the overflowing of liquid detergent.

### BRIEF DESCRIPTION OF THE DRAWINGS

The above and other objects, features and advantages of the present invention will be more clearly understood by reference to the following detailed description taken in conjunction with the accompanying drawings, in which:

FIG. 1 is a perspective view of a detergent supply apparatus of a washing machine in accordance with an embodiment of the present invention;

FIG. 2 is a schematic view of the detergent supply apparatus of the washing machine in accordance with an embodiment of the present invention;

FIG. 3 is an exploded plan of the detergent supply apparatus in FIGS. 1 and 2;

FIG. 4 is a plane plan of the detergent supply apparatus in FIGS. 1 and 2;

FIG. 5 is a sectional plan of the line A-A in FIG. 4;

FIG. 6 is a sectional plan of the line B-B in FIG. 4.

### DETAILED DESCRIPTION OF THE PREFERRED EMBODIMENT

Now, the preferred embodiment of the present invention will be hereinafter described in detail with reference to the accompanying drawings.

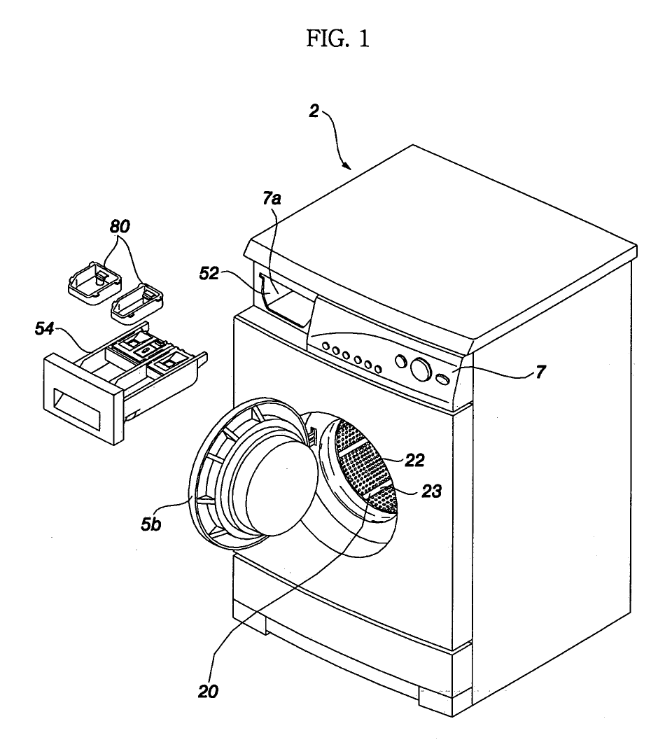

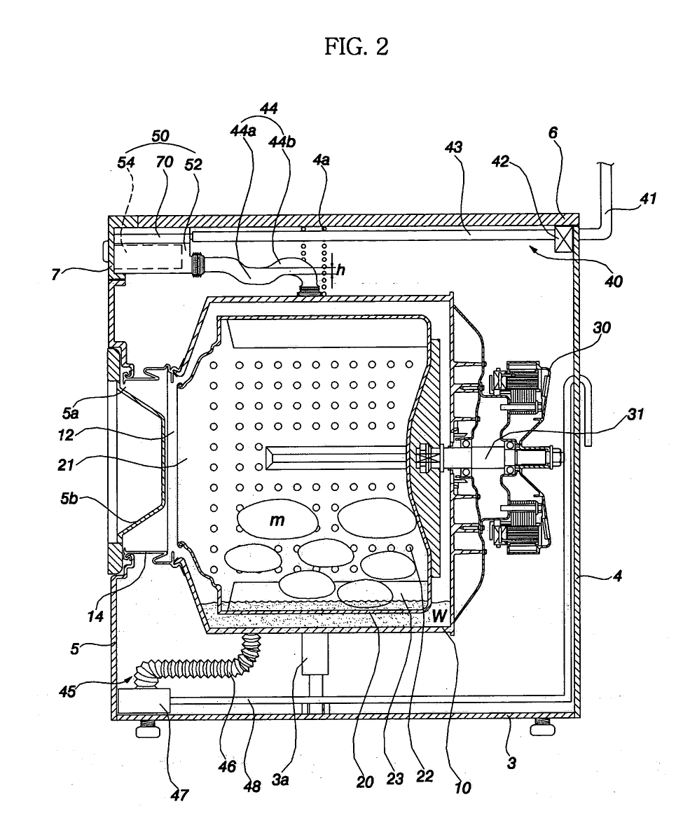

FIG. 1 is a perspective view of a detergent supply apparatus of a washing machine in accordance with an embodiment of the present invention, and FIG. 2 is a schematic view of the detergent supply apparatus of the washing machine in accordance with an embodiment of the present invention

As shown in FIGS. 1 and 2, the washing machine according to the embodiment comprises a casing 2, a tub 10 suspended in a casing 2 by a shock absorber to contain water with detergent or clean water (w, hereinafter referred as “washing water”), a drum 20 rotatably set in the tub 10 to receive laundry(m), a driving motor 30 which makes the drum 20 rotate, a water supplier 40 which supplies water to the tub 10, a water drainer 45 which drains contaminated water in the tub 10 or dehydrated water from laundry(m) out of the washing machine, and the detergent supply apparatus 50 connected to the water supplier 40 in order to mix detergent in water from the water supplier 40.

The casing 2 comprises a base 3 having a damper 3a to uphold the tub 10, a cabinet 4 having a spring 4a in both sides to hang the tub 10, which is located in a top of the base 3 to surround both sides and a rear of the tub 10, a cabinet cover 5 having an entrance hole 5a in a middle to place and remove laundry(m) and a door 5b to open and close the entrance hole 5a, which is located in a front of the cabinet 4, and a top plate 6 which covers a top surface of the cabinet 4.

A control panel 7 is installed in an upper part of the cabinet cover 5 in order to manipulate the washing machine.

The control panel 7 has an entrance hole for a detergent container 7a which will be mentioned later.

An opening 12 is formed on a front of the tub 10 to allow laundry(m) to put in and out from the drum 20, and a gasket 14 is mounted around the opening 12 to prevent water from leaking and laundry(m) from separating by closely adhering to a rear surface of the door 5b.

The drum 20 has an entrance hole 21 for placing and removing laundry(m) in the front of the tub 10. A plurality of perforations 22 for going in and out washing water is existed in a circumference or the rear of the tub 10. A lifter 23 for moving upward and dropping laundry(m) is installed in an inner circumference of the tub 10. A bottom of the drum 20 is submerged in washing water(w) in the tub 10.

The driving motor 30 is set in a rear surface of the tub 10 and connected to a rear surface of the drum 20, as a shaft 31 which penetrates the rear of the tub 10 is supported by a bearing of the tub 10.

The water supplier 40 connected to an external hose 41, referring to FIG. 2, comprises a water supply valve 42 to control water supplied through the external hose 41, a plurality of water supply hoses 43 to guide water through the water supply valve 42 to the detergent supply apparatus 50, and a water supply bellows tube 44 to guide washing water through the detergent supply apparatus 50 to the inside of the tub 10.

The water supply valve 42 includes 3 cold water valves and 1 hot water valve.

The water supply hose 43 includes 3 cold water hoses and 1 hot water hose.

Though air within a housing 52 which will be mentioned later may move to the tub 10 through the water supply bellows tube 44, steam flowing backward from the tub 10 as drying or heating washing is condensed by water contained in the water supply bellow tube 44.

The water supply bellows tube 44 has a 1^{st} bending portion 44a in the shape of ∪ and a 2^{nd} bending portion 44b in the shape of ∩, on one side. Water is sank to a bottom of an inner horizontal portion in the 1^{st} bending portion 44a, and a top of the horizontal portion in the 1^{st} bending portion 44a is placed higher than a bottom of the horizontal portion in the 2^{nd} bending portion 44b by predetermined height (h). An air passage is made in the top of the inner horizontal portion in the 1^{st} bending portion 44a and in the inner horizontal portion in the 2^{nd} bending portion 44b.

The water drainer 45 comprises a water drain bellows tube 46 connected to an overflow of the tub 10 in order to discharge washing water into the tub 10, a water drain pump 47 to pump water drained to the water drain bellows tube 46, and a water drain hose 48 to guide washing water pumped by the water drain pump 47 out of the washing machine.

As seen in FIGS. 1 and 2, the detergent supply apparatus 50 comprises the housing 52 placed in one end of the control panel 7 and connected to the water supply bellows tube 44, which is open at its front and top, a detergent container 54 installed in the housing 52 to move forward through a front of the housing 52, a cover 70 (hereinafter referred as “dispenser”) to cover a top surface of the housing 52, installed in a top of the housing 52 and to supply water to the detergent container 54, connected to the water supply hose 43, and a liquid detergent container 80 detachably set in the detergent container 54 so as to mix and supply liquid detergent and water supplied to the detergent container 54.

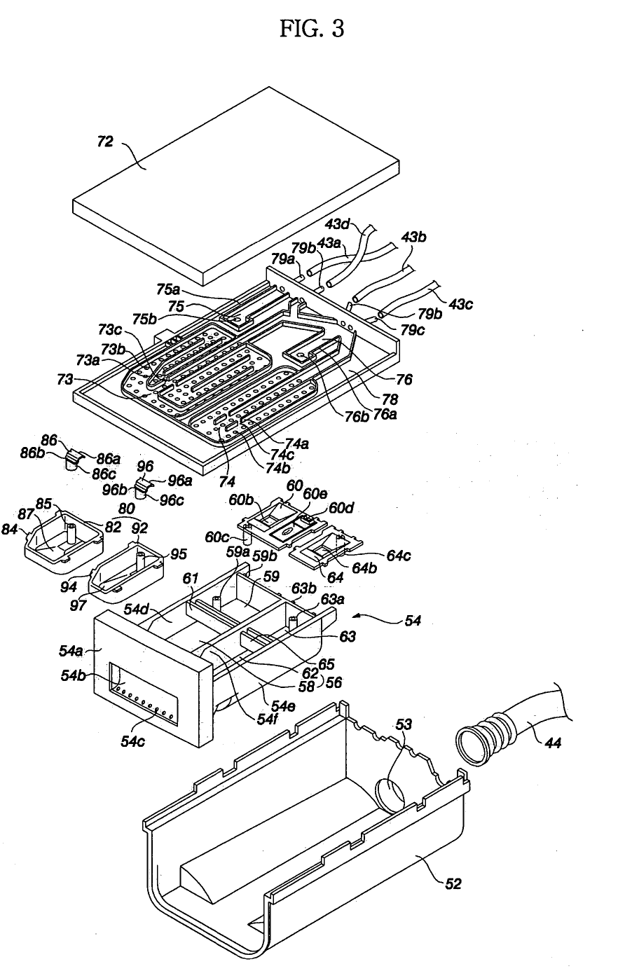

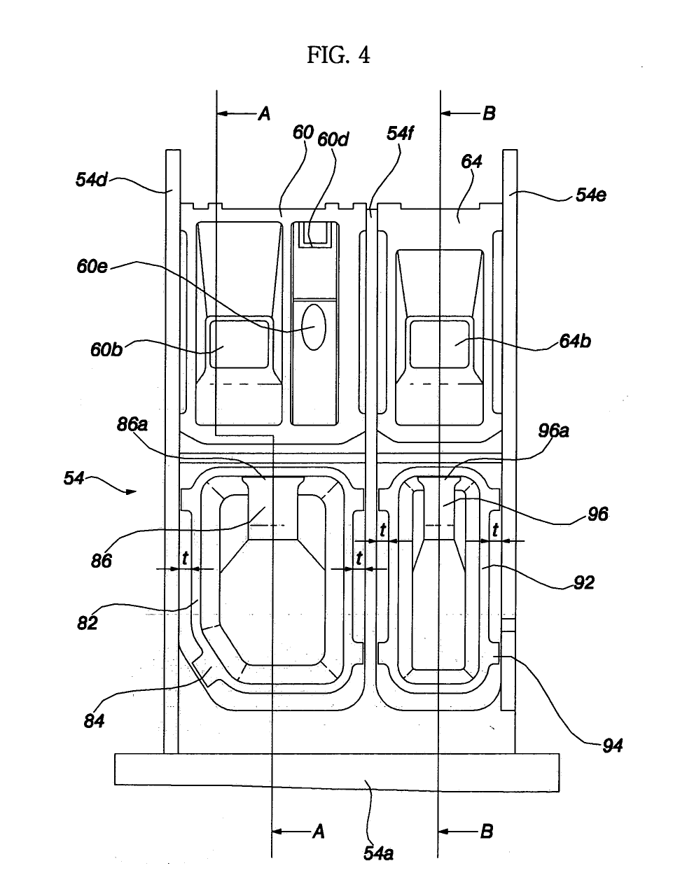

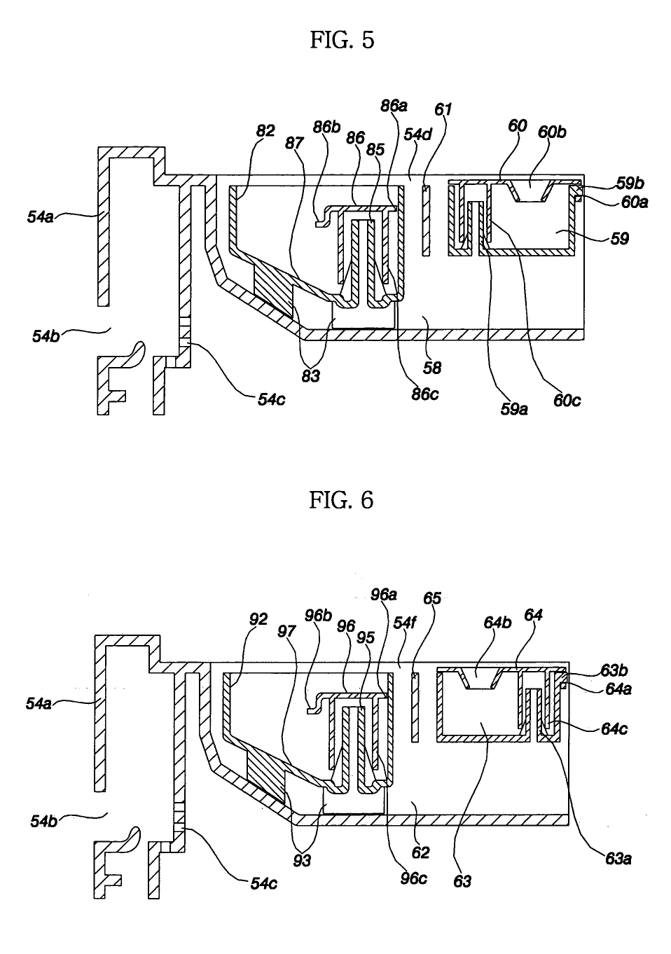

FIG. 3 is an exploded plan of the detergent supply apparatus in FIGS. 1 and 2, and FIG. 4 is a plane plan of the detergent supply apparatus in FIGS. 1 and 2. FIG. 5 is a sectional plan of the line A-A in FIG. 4, and FIG. 6 is a sectional plan of the line B-B in FIG. 4.

As illustrated in FIGS. 3 or 6, an outlet 53 is formed on the housing 52, where water and detergent dropped from the detergent container 54 is discharged into the water supply bellows tube 44.

A handle hole 54b is formed on a front portion 54a of the detergent container 54, which is open at its rear and top.

A ventilation hole 54c is formed at a back of the handle hole 54b so as to inflow external air in the housing 52.

The detergent container 54 has a powdered detergent chamber 56 to mix and supply powdered detergent and water.

A partition wall 54f is formed in the detergent container 54, dividing the powdered detergent chamber 56 to include a main detergent storing section 58 and a preliminary detergent storing section 62, which is separated from both sidewalls 54d, 54e of the detergent container 54 by predetermined distance.

The detergent container 54 has a bleach storing section 59 where bleach is accommodated and a siphon 59a is protruded.

As shown in FIGS. 3 and 5, the bleach storing section 59 is positioned in a rear and top of the main detergent storing section 58. Its bottom is distant from the corresponding area of the main detergent storing section 58 by predetermined distance, which is open at its top.

A bleach cover 60 is provided with the siphon 59a and a water drain passage in the bleach storing section 59.

The bleach cover 60 is enough to cover a top surface of the bleach storing section 59, a hook hole 60a suspended in a hook 59b and a bleach input hole 60b for placing bleach are formed therein.

A bottom of the bleach cover 60 has a bleach siphon 60c that bleach and water moves upward at an interval with the siphon 59a, apart from the siphon 59a by predetermined distance.

The bleach cover 60 has a hanging protrusion 60d suspended in the control panel 7 or the dispenser 70 when the detergent container 54 is pulled forward, and an elastic portion 60e which enables to push by lowering the hanging protrusion not to make the hanging protrusion 60d suspended in the control panel 7 or the dispenser 70.

A main detergent clogging-protection rib 61 is formed in the detergent container 54 so as to prevent a bottom of the bleach storing section 59 from clogging, apart from a front of the bleach storing section 59 and from a bottom of the main detergent storing section 58 by predetermined distance.

The detergent container 54 has a fabric softner storing section 63 where fabric softner is accommodated and a siphon 63a is protruded.

As shown in FIGS. 3 and 6, the fabric softner storing section 63 is positioned in a rear and top of the preliminary detergent storing section 62. Its lower portion is distant from the corresponding area of the preliminary detergent storing section 62 by predetermined distance, which is open at its top.

A fabric softner cover 64 is enough to cover a top surface of the fabric softner storing section 63, a hook hole 64a suspended in a hook 63b and a fabric softner input hole 64b for placing fabric softner are formed therein.

A bottom of the fabric softner cover 64 has a fabric softner siphon 64c that fabric softner and water moves upward at an interval with the siphon 63a, apart from the siphon 63a by predetermined distance.

A preliminary detergent clogging-protection rib 65 is formed in the preliminary detergent storing section 62 so as to prevent a bottom of the fabric softner storing section 63 from clogging, apart from a front of the fabric softner storing section 63 and from a bottom of the preliminary detergent storing section 62 by predetermined distance.

The dispenser 70, as illustrated in FIG. 3, comprises an upside panel 72 and a downside panel 78 having a main detergent water supply passage 73, a preliminary detergent water supply passage 74, a bleach water supply passage 75, and a fabric softner water supply passage 76.

In one end either of the upside panel 72 or the downside panel 78, a main detergent water supply rib 73a for the main detergent water supply passage 73, a preliminary detergent water supply rib 74a for the preliminary detergent water supply passage 74, a bleach water supply rib 75a for the bleach water supply passage 75, and a fabric softner water supply rib 76a for the fabric softner water supply passage 76 are located.

The downside panel 72 has a plurality of main detergent water supply holes 73b in a front and top of the main detergent storing section 58, a plurality of preliminary detergent water supply holes 74b in a front and top of the preliminary detergent storing section 62, a plurality of bleach water supply holes 75b in a front and top of the bleach storing section 59, and a plurality of fabric softner water supply holes 76b in a front and top of the fabric softner storing section 63.

The main detergent water supply rib 73a has a bypass hole 73c to make some water through the main detergent water supply passage 73 detoured to a front of the main detergent water supply holes 73b.

The preliminary detergent water supply rib 74a has a bypass hole 74c to make some water through the preliminary detergent water supply passage 74 detoured to a front of the preliminary detergent water supply holes 74b.

The upside panel 72 and the downside panel 78 are assembled by melting bond.

In one end either of the upside panel 72 or the downside panel 78, there are a 1^{st} hose connection 79a connected to the 1^{st} cold water hose 43a in order to supply cold water to the bleach water supply passage 75, and a 2^{nd}, 3^{rd}, 4th hose connection 79b, 79c, 79d connected to the 2^{nd}, 3^{rd} cold water hose 43b, 43c and the hot water hose 43d to optionally supply cold water or hot water to the main detergent water supply passage 73, the preliminary detergent water supply passage 74, and the fabric softner water supply passage 76.

The liquid detergent container 80, as referring to FIGS. 3 or 6, is possible to furnish with both a main liquid detergent container 82 detachably set in the main detergent storing section 58 and a subsidiary liquid detergent container 92 detachably set in the preliminary detergent storing section 62. Or, it is possible to furnish with either the liquid detergent container 82 detachably set in the main detergent storing section 58, or the liquid detergent container 92 detachably set in the preliminary detergent storing section 62.

The main liquid detergent container 82, as referring to FIG. 5, is inserted into a front of the main detergent storing section 58. Its height is lower than that of the main detergent storing section 58 when installed.

The subsidiary liquid detergent container 92, as referring to FIG. 6, is inserted into a front of the preliminary detergent storing section 62. Its height is lower than that of the preliminary detergent storing section 62 when installed.

The liquid detergent container 82, 92, as referring to FIGS. 5 and 6, comprises a plurality of protrusions 83, 93 on a bottom of the powdered detergent chamber 56 to separate from the bottom of the powdered detergent chamber 56 by predetermined distance.

As illustrated in FIGS. 3 and 4, the width of the liquid detergent container 82, 92 is narrower than that of a sidewall 54d, 54e, 54f of the powdered detergent chamber 56. Thus, there is a slit(t) between the sidewall 54d, 54e, 54f of the powdered detergent chamber 56 and that of the liquid detergent container. A plurality of protrusions 84, 94 is existed to separate from the sidewalls 54d, 54e, 54f of the powdered detergent chamber 56 by predetermined distance.

Since overflowed water from the liquid detergent container 82, 92 is drained through the slit(t), it does not flow to another place.

The liquid detergent container 82, 92 has a protruded siphon 85, 95 and a liquid detergent siphon cover 86, 96 which covers the siphon 85, 95 and provides the water drain passage together with the siphon.

The liquid detergent container 82, 92 has a downward sloping surface 87, 97 toward the siphon 85, 95 in a lower part.

The liquid detergent siphon cover 86, 96 has a straight portion 86a, 96a which is suspended on a wall of the liquid detergent container 82, 92 so as to restrict its rotation.

The liquid detergent siphon cover 86, 96 has an indication portion 86b, 96b in a stepwise manner, which shows the maximum quantity of liquid detergent.

The liquid detergent siphon cover 86, 96 has a liquid detergent siphon 86c, 96c where liquid detergent and water moves upward at an interval with the siphon 85, 95, apart from the siphon 85, 95 by predetermined distance.

The process for the present invention will be described below.

Supposing that liquid detergent is used for the preliminary and main washing process, first, the main liquid detergent container 82 is inserted into the main detergent storing section 58 and the subsidiary liquid detergent container 92 is inserted into the preliminary detergent storing section 62, then, liquid detergent is poured into the main liquid detergent container 82 and the subsidiary liquid detergent container 92.

Laundry(m) is received in the drum 20, the door 5b is closed, and the control panel 7 orders the washing machine to operate. The washing machine checks a washing mode and makes water supply started.

At least one of the water supply valves 42 supplies water supplied through the external hose 41 to the preliminary detergent water supply passage 74 within the dispenser 70. Water falls toward the front of the preliminary detergent storing section 62 through the preliminary detergent water supply holes 74b.

The water supply valve 42 operated to supply water to the preliminary detergent water supply passage 74 allows water to pass intermittently in order to prevent liquid detergent or water from overflowing in case that excessive water is supplied to the subsidiary liquid detergent container 92.

That is, the water supply valve 42 operated to supply water to the preliminary detergent water supply 74 becomes on for the 1^{st} setting time, and becomes off for the 2^{nd} setting time. Such on and off is repeated.

The 1^{st} setting time and the 2^{nd} setting time are advisable to set depending on a capacity of the subsidiary liquid detergent container 92.

Water fallen toward the front of the preliminary detergent storing section 62 is contained in the subsidiary liquid detergent container 92 and mixed with liquid detergent which has been put therein.

Mixed liquid detergent and water, as illustrated in FIG. 6, ascends between the siphon 95 of the subsidiary liquid detergent container 92 and the liquid detergent siphon 96c of the liquid detergent siphon cover 96, and descends through the siphon 95 of the subsidiary liquid detergent container 92, then, falls toward the bottom of the preliminary detergent storing section 62.

Liquid detergent and water fallen toward the bottom of the preliminary detergent storing section 62 moves to a back of the preliminary detergent storing section 62, subsequently to the housing 52. After going through the outlet 53 of the housing 52, the water supply bellow tube 44 in turn and getting to the tub 10, preliminary washing is operated when the drum 20 rotates by the driving motor 30.

When preliminary washing is completed and main washing is started, at least one of the water supply valves 42 supplies water supplied through the external hose 41 to the main detergent water supply passage 73 within the dispenser 70. Water falls toward the front of the main detergent storing section 58 through the main detergent water supply holes 73b.

The water supply valve 42 operated to supply water to the main detergent water supply passage 73 allows water to pass intermittently in order to prevent liquid detergent or water from overflowing like preliminary washing.

That is, the water supply valve 42 operated to supply water to the main detergent water supply 73 becomes on for the 3^{rd} setting time, and becomes off for the 4^{th} setting time. Such on and off is repeated.

The 3^{rd} setting time and the 4^{th} setting time are advisable to set depending on the capacity of the main liquid detergent container 82.

Water fallen toward the front of the main detergent storing section 58 is contained in the main liquid detergent container 82 and mixed with liquid detergent which has been put therein.

Mixed liquid detergent and water, as illustrated in FIG. 5, ascends between the siphon 85 of the main liquid detergent container 82 and the liquid detergent siphon 86c of the liquid detergent siphon cover 86, and descends through the siphon 85 of the main liquid detergent container 82, then, falls toward the bottom of the main detergent storing section 58.

Liquid detergent and water fallen toward the bottom of the main detergent storing section 58 moves to a back of the main detergent storing section 58, subsequently to the housing 52. After getting to the tub 10 like preliminary washing, main washing is operated when the drum 20 rotates by the driving motor 30.

The washing machine operates main washing and drains contaminated water out of the washing machine. The next operation is performed according to an option for rinsing or dehydrating.

When rinse is chosen, the water supply valve 42 is turned on and clean water is supplied. Clean water, in the same manner as the above washing, passes within the dispenser 70 and falls toward the main liquid detergent container 82 or the subsidiary liquid detergent container 92. It moves to the back of the main detergent storing section 58 or the preliminary detergent storing section 62, subsequently to the housing 52.

Water moved to the housing 52 is supplied to the tub 10 and rinses laundry when drum 20 rotates by the driving motor 30.

The washing machine operates main washing and drains contaminated water out of the washing machine. It repeats water supply, rinse and drain according to the setting frequency.

Then, when dehydration is chosen, the drum 20 rotates with high speed by the driving motor 30 and moisture left in laundry(m) is dehydrated.

Supposing that bleach is used for washing, bleach is poured into the bleach storing section 59 and the washing machine is operated. At least one of the water supply valves 42 supplies water supplied through the external hose 41 to the bleach water supply passage 75 within the dispenser 70. Water falls toward the back of the main detergent storing section 58 through the bleach water supply holes 75b.

The water supply valve 42 operated to supply water to the bleach water supply passage 75 allows water to pass intermittently in order to prevent bleach or water from overflowing like preliminary washing or main washing.

That is, the water supply valve 42 operated to supply water to the bleach water supply passage 75 becomes on for the 5^{th} setting time, and becomes off for the 6^{th} setting time. Such on and off is repeated.

The 5^{th} setting time and the 6^{th} setting time are advisable to set depending on the capacity of the bleach storing section 59.

Water fallen toward the back of the main detergent storing section 58 is contained in the bleach storing section 59 and mixed with bleach which has been put therein.

Mixed bleach and water ascends between the siphon 59a of the bleach storing section 59 and the bleach siphon 60c of the bleach cover 60, and descents through the siphon 59a of the bleach storing section 59, then, falls toward the bottom of the main detergent storing section 58. Fallen bleach and water is supplied for the tub 10 like preliminary washing and main washing. With that, it improves washing power.

Supposing that fabric softner is used for the rinsing process, fabric softner is poured in the fabric softner storing section 63 and the washing machine is operated. The washing machine rinses more than once and fabric softner is supplied together with water in the last rinsing stage.

Before the last rinse, at least one of the water supply valves 42 supplies water supplied through the external hose 41 to the fabric softner water supply passage 76 within the dispenser 70. Water falls toward the back of the preliminary detergent storing section 62 through the fabric softner water supply holes 76b.

The water supply valve 42 operated to supply water to the fabric softner water supply passage 76 allows water to pass intermittently in order to prevent fabric softner or water from overflowing like preliminary washing or main washing.

That is, the water supply valve 42 operated to supply water to the fabric softner water supply passage 76 becomes on for the 7^{th} setting time, and becomes off for the 8^{th} setting time. Such on and off is repeated.

The 7^{th} setting time and the 8^{th} setting time are advisable to set depending on the capacity of the fabric softner storing section 63.

Water fallen toward the back of the preliminary detergent storing section 62 is contained in the fabric softner storing section 63 and mixed with fabric softner which has been put therein.

Mixed fabric softner and water ascends between the siphon 63a of the fabric softner storing section 63 and the fabric softner siphon 64c of the fabric softner cover 64, and descends through the siphon 63a of the fabric softner storing section 63, then, falls toward the bottom of the preliminary detergent storing section 62. Fallen fabric softner and water is supplied to the tub 10 like preliminary washing and main washing. With that, it helps laundry(m) more softened.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

For example, the case that the liquid detergent container is inserted into either the main detergent storing section 58 or the preliminary detergent storing section 62 should be interpreted as the claim to the present invention.

As described above, a liquid detergent container in accordance with a detergent supply apparatus of a washing machine is installed in a powdered detergent chamber of a detergent container, which mixes and supplies liquid detergent and water together. Supply of liquid detergent is simple. Liquid detergent diluted with water soaks laundry, therefore, decoloration and discoloration of laundry can be protected.

The liquid detergent container is detachably set in the powdered detergent chamber of the detergent container, therefore, liquid detergent or powdered detergent can be easily put in depending on a user's intention

The detergent container has the powdered detergent chambers and the liquid detergent container is detachably set in one of the powdered detergent chambers, therefore, liquid detergent and powdered detergent can be used together.

The powdered detergent chamber is divided into a main detergent storing section and a preliminary detergent storing section. The liquid detergent container includes a main liquid detergent container detachably set in the main detergent storing section and a subsidiary liquid detergent container detachably set in the preliminary detergent storing section. If either the main liquid detergent container or the subsidiary liquid detergent container is installed in the detergent container, a different type of detergent can be used in main washing and preliminary washing. Therefore, the washing power can be much more improved.

A bottom of the liquid detergent container is parted from that of the powdered detergent chamber by predetermined distance, therefore, liquid detergent and water can easily flow without stagnating.

A side of the liquid detergent container is parted from that of the powdered detergent chamber by predetermined distance and a top of the liquid detergent container is lower than that of the powdered detergent chamber, therefore, liquid detergent and water does not overflow into another place. It can prevent the unnecessary use of detergent.

The liquid detergent container has a protruded siphon and a liquid detergent siphon cover which covers the siphon and provides a water drain passage together with the siphon, therefore, mixing and supplying liquid detergent and water is simply possible.

The bottom of the liquid detergent container has a downward sloping surface toward the siphon, therefore, remaining liquid detergent can be minimized.

The liquid detergent siphon cover has a straight portion which is suspended on a wall of the liquid detergent container in order to restrict its rotation, therefore, an additional structure, i.e. a hook, fixing the liquid detergent siphon cover is not required and noise from the vibration of the washing machine can be minimized.

The liquid detergent siphon cover has an indication portion in a stepwise manner, which shows the maximum quantity of liquid detergent, therefore, the user can easily notice the maximum quantity of liquid detergent. It can prevent the excessive use of liquid detergent, even the overflowing of liquid detergent.

1. A detergent supply apparatus of a washing machine, comprising:
a detergent container having a powdered detergent chamber which stores powdered detergent; and
a liquid detergent container or a plurality of liquid detergent containers storing liquid detergent, said liquid detergent container detachably set in the powdered detergent chamber.

2. The detergent supply apparatus of the washing machine as set forth in claim 1, wherein a detergent chamber is partitioned into a plurality of powdered detergent sections, and the liquid detergent container is detachably set in each of the powdered detergent sections.

3. The detergent supply apparatus of the washing machine as set forth in claim 1, wherein the powdered detergent chamber is partitioned into a main detergent storing section for main washing and a preliminary detergent storing section for preliminary washing.

4. The detergent supply apparatus of the washing machine as set forth in claim 1, wherein the liquid detergent containers include a main liquid detergent container detachably set in a main detergent storing section and a subsidiary liquid container detachably set in a preliminary detergent storing section.

5. The detergent supply apparatus of the washing machine as set forth in claim 1, wherein the detergent container includes:
a fabric softner storing section where fabric softner is contained and a siphon is protruded; and
a fabric softner cover which covers the fabric softner storing section and provides a water drain passage with the siphon.

6. The detergent supply apparatus of the washing machine as set forth in claim 1, wherein the detergent container includes:
a bleach storing section where bleach is contained and a siphon is protruded; and
a bleach cover which covers the bleach storing section and provides a water drain passage with the siphon.

7. The detergent supply apparatus of the washing machine as set forth in claim 1, wherein the liquid detergent container has at least one protrusion which parts a bottom of the liquid detergent container from a bottom of the powdered detergent chamber by predetermined distance.

8. The detergent supply apparatus of the washing machine as set forth in claim 1, wherein the liquid detergent container has a plurality of protrusions which part a side of liquid detergent container from a side of the powdered detergent chamber by predetermined distance.

9. The detergent supply apparatus of the washing machine as set forth in claim 1, wherein height of the liquid detergent container is lower than height of the powdered detergent chamber.

10. The detergent supply apparatus of the washing machine as set forth in claim 1, wherein the liquid detergent container has a siphon upwardly protruded and a liquid detergent siphon cover which covers the siphon and provides a water drain passage with the siphon.

11. The detergent supply apparatus of the washing machine as set forth in claim 10, wherein a bottom of the liquid detergent container has a downward sloping surface toward the siphon.

12. The detergent supply apparatus of the washing machine as set forth in claim 10, wherein the liquid detergent siphon cover has a straight portion which is suspended on a wall of the liquid detergent container so as to restrict rotation of the liquid detergent siphon cover.

13. The detergent supply apparatus of the washing machine as set forth in claim 10, wherein the liquid detergent siphon cover has an indication portion in a stepwise manner, which shows the maximum quantity of liquid detergent.

14. A detergent supply apparatus of a washing machine, comprising:
a housing installed in the washing machine;
a detergent container inserted in the housing; and
at least one liquid detergent container detachably set in the detergent container.

15. A detergent supply apparatus of a washing machine, comprising:
a housing installed in the washing machine, said housing opening at a front and top portion;
a detergent container having a detergent chamber which stores powdered detergent, said detergent container inserted into the housing through a front of the housing;
a dispenser having a plurality of water supply passages to inject water into the detergent chamber, said dispenser covering a top surface of the housing; and
a liquid detergent container or a plurality of liquid detergent containers detachably set in the detergent chamber so as to mix and supply liquid detergent and water.

16. The detergent supply apparatus of the washing machine as set forth in claim 15, wherein the detergent container is partitioned into a plurality of detergent sections.

17. The detergent supply apparatus of the washing machine as set forth in claim 15, wherein the detergent chamber includes a main detergent storing section, a preliminary detergent storing section, a bleach storing section, and a fabric softner storing section.

18. The detergent supply apparatus of the washing machine as set forth in claim 15, wherein the liquid detergent container has a siphon upwardly protruded and a liquid detergent siphon cover which covers the siphon and provides with a water drain passage and the siphon.

19. A washing machine comprising:
a cabinet;
a tub installed in the cabinet;
a drum rotatably set in the tub;
a housing installed in the cabinet;
a detergent container having a powdered detergent chamber in order to mix and supply powdered detergent and water, said detergent container inserted into the housing;
a dispenser having a water supply passage to inject water into the powdered detergent chamber, said dispenser covering a top surface of the housing; and
a liquid detergent container or a plurality of liquid detergent containers detachably set in the powdered detergent chamber in order to mix and supply liquid detergent and water.
